(19) United States
(12) Patent Application Publication
(10) Pub. No.: US 2013/0337304 A1
(43) Pub. Date: Dec. 19, 2013

(54) POUCH CELL COMPRISING AN EMPTY-VOLUME DEFINING COMPONENT

(71) Applicants: Shalom Luski, Rehovot (IL); Arieh Meitav, Rishon Lezion (IL)

(72) Inventors: Shalom Luski, Rehovot (IL); Arieh Meitav, Rishon Lezion (IL)

(73) Assignee: ETV ENERGY LTD., Herzliya (IL)

(21) Appl. No.: 14/001,176

(22) PCT Filed: Feb. 26, 2011
(86) PCT No.: PCT/IB11/50836

§ 371 Date: Aug. 23, 2013

(51) Int. Cl. H01M 10/52

(52) U.S. Cl. CPC H01M 10/52
USPC 429/94; 429/127

(57) ABSTRACT

Disclosed are pouch cells, for example lithium-ion pouch cells, where a portion of the inner volume of the pouch is substantially empty and there is subatmospheric pressure inside the pouch. In some embodiments gas released inside the pouch, for example during use of the cell, is accommodated in the substantially empty portion of the inner volume of the pouch, avoiding pouch bulging.

### FIELD AND BACKGROUND OF THE INVENTION

The invention, in some embodiments, relates to the field of batteries and more particularly, but not exclusively, to pouch cells including a flexible shell.

Traditional batteries include a rigid cylindrical shell of metal (often called a can) which defines the size and shape of the battery, and in some cases functions as an electrode or current collector.

Recent developments in battery chemistry, particularly lithium-ion chemistry, allow greater flexibility in design of a battery shell such as the pouch cell described, for example, in U.S. Pat. Nos. 6,042,966; 6,048,638; 6,296,967; 6,337,154; U.S. patent application publication Nos. 2008/0254367, 2008//0241671; 2008/0292962; 2008/0311469; 2009/0023062; 2009/0029245 and PCT patent publication WO 2006/073277.

A pouch cell includes a flexible shell in the form of a pouch typically fashioned of a heat-sealable laminated foil. The pouch contains the electrodes and other cell-components, with positive and negative contacts functionally associated with the electrodes, for example by welding, protruding from a sealed seam of the pouch.

Typical pouch cells are schematically depicted in FIGS. 1A, 1B, 1C and 1D.

A typical lithium-ion chemistry pouch cell 10, schematically depicted in perspective in FIG. 1A and longitudinal cross section (B-B) in FIG. 1B, comprises a positive electrode layer 12 (cathode during discharge, comprising a positive active material) and a negative electrode layer 14 (anode during discharge, comprising a negative active material), separated by a separator layer 16 permeable to the passage of lithium ions. Taken together, positive electrode layer 12, negative electrode layer 14 and separator layer 16 constitute a flat laminated electrode assembly 18. Electrode assembly 18 is contained inside a flexible shell in the form of a pouch 20 of aluminized polypropylene foil and is saturated with an electrolyte (generally a liquid or gel, e.g., LiF₆ electrolyte salt in a non-aqueous solvent comprising ethylene carbonate). Functionally associated with positive electrode layer 12 and protruding through a seam in pouch 20 is positive contact 22. Functionally associated with negative electrode layer 14 and protruding through a seam in pouch 20 is negative contact 24.

Pouch cells including a flat laminated electrode assembly such as pouch cell 10 are generally made by stacking the separate sheets constituting positive electrode layer 12 (with attached positive contact 22), negative electrode layer 14 (with attached negative contact 24) and separator layer 16 so that separator layer 16 prevents any direct physical contact between positive electrode layer 12 and negative electrode layer 14 that would lead to a short-circuit.

The thus-assembled flat laminated electrode assembly 18 is placed in an incipient pouch 20 and the periphery of the incipient pouch 20 sealed to make a seam in such a way that contacts 22 and 24 protrude from pouch 20 through the seam, and leaving a small gap in the seam into which a vacuum conduit is placed. The incipient pouch 20 is made in any suitable way, for example from two stacked sheets, from a single folded sheet, and even from a preformed pouch with part of the pouch periphery left open for placement of electrode assembly 18.

Subsequently, gas in pouch 20 is evacuated through the vacuum conduit. When a sufficient vacuum is reached, a valve is activated allowing electrolyte to be introduced into pouch 20 without breaking the vacuum. The electrolyte is absorbed into volumes and pores in separator layer 16 and electrode layers 12 and 14, saturating electrode assembly 18. The amount of electrolyte inside pouch 20 is such that pouch 20 is entirely filled and there is no empty volume inside pouch 20 except, possibly for an insubstantial volume determined by the vapor pressure of electrolyte components and the temperature.

A pouch cell 26 is depicted in transverse cross section (A-A) in FIG. 1C and in longitudinal cross section (B-B) in FIG. 1D. Pouch cell 26 is similar to pouch cell 10 depicted in FIGS. 1A and 1B but instead of a flat laminated electrode assembly 18, pouch cell 26 includes a spiral laminated electrode assembly 28 (jelly roll) with a core 30 including a positive electrode layer 12, a negative electrode layer 14 and two separator layers 16a and 16b.

In order to make a spiral electrode assembly such as 28, four separate spools (one holding a wound ribbon of positive electrode layer material, one holding a wound ribbon of negative electrode layer material and two holding wound ribbons of separator layer material) and a rotatable rectangular mandrel are provided. Two ends of separator layer material from the two spools are secured to the mandrel and the mandrel rotated to wind one or more winds of the two separator layers around the mandrel. Rotation of the mandrel is stopped and an end of one the electrode materials is placed between the two separator layers and the end of the second electrode material is placed on an opposite side of one of the two separator layers. The mandrel is again rotated. As the mandrel rotates, the four ribbons are drawn from the four spools and wound about the mandrel, making a spiral laminated electrode assembly such as 28. When the desired number of winds is achieved, rotation is stopped, the ribbons of material are separated from the spools and the mandrel is withdrawn from core 30.

Analogously to flat electrode assembly 18 of pouch cell 10, spiral electrode assembly 28 is placed inside a flexible shell in the form of a pouch 20. The application of vacuum collapses core 30 so that the volume formerly occupied by the mandrel is substantially filled with the inner ends of separator layers 16a and 16b. It is important to note that in FIGS. 1C and 1D, core 30 is depicted with “empty” volume in addition to separator layers 16a and 16b. The thus-depicted “empty” volume is apparent only for clarity of illustration: in reality, the empty volume is non-existent.

Typically, electrode layers such as 12 and 14, for example for a lithium-ion chemistry pouch cell, are between 30 and 300 micrometer thick, more usually between 100 and 200 micrometers thick.

In order to increase the power density of a pouch cell, it is preferred that a separator layer be as thin as possible. However, a separator layer must be strong enough to maintain physical integrity and to prevent short-circuits. Typically, a separator layer is made of a microporous polyolefin (e.g., polypropylene or polyethylene) or fluorinated polyolefin film inert to the components of the electrolyte 10 to 30 micrometers thick, having a porosity of between about 20-35%.

A known disadvantage of pouch cells such as 10 and 26 occurs when gas is generated inside the pouch during use, see for example U.S. Pat. No. 6,048,638. The produced gas leads to bulging of the pouch, which may adversely affect cell performance. For example, when bulging occurs, electrode layers 12 and 14 may have insufficient contact with a separator layer 16, leading to a rise in internal impedance.

### SUMMARY OF THE INVENTION

Some embodiments of the invention relate to pouch cells that, in some aspects, have advantages over known pouch cells. Some embodiments of the invention relate to methods of making a pouch cell.

According to an aspect of some embodiments of the invention, a pouch cell, such as a lithium-ion chemistry pouch cell, is provided where a portion of the inner volume of the pouch is substantially empty and the pressure inside the pouch is subatmospheric. In some embodiments, the substantially empty portion is such that at least some of a gas produced inside the pouch, for example due to decomposition of components of the electrolyte, is accommodated in the substantially empty portion of the inner volume of the pouch. In some such embodiments, such decomposition of electrolyte to form a gaseous product adversely affects cell performance to a lesser degree due to accommodation of the gas product in the substantially empty portion of the inner volume of the pouch. In some such embodiments, the extent of pouch bulging as a result of gas produced inside the pouch is reduced (or even prevented) due to accommodation of the gas product in the substantially empty portion of the inner volume of the pouch.

Thus, according to an aspect of some embodiments of the invention there is provided a pouch cell, comprising:
a) a flexible shell in the form of a pouch;
b) inside the pouch, a laminated electrode assembly, comprising a positive electrode layer, a negative electrode layer and a separator layer disposed between the positive electrode layer and the negative electrode layer; and
c) inside the pouch, an amount of electrolyte such that a portion of the inner volume of the pouch is substantially empty
   wherein the pressure inside the pouch is subatmospheric.

According to an aspect of some embodiments of the invention there is also provided a pouch cell, comprising:
a) a flexible shell comprising a pouch;
b) inside the pouch, a laminated electrode assembly, comprising a positive electrode layer, a negative electrode layer and a separator layer disposed between the positive electrode layer and the negative electrode layer;
c) inside the pouch, an amount of electrolyte such that a portion of the inner volume of the pouch is substantially empty; and
d) inside the pouch, an empty-volume defining component
   wherein the pressure inside the pouch is subatmospheric.

According to an aspect of some embodiments of the invention there is also provided a method of making a pouch cell comprising:
a) inside a flexible shell comprising a pouch placing:
   a laminated electrode assembly, comprising a positive electrode layer, a negative electrode layer and a separator layer disposed between the positive electrode layer and the negative electrode layer; and an empty-volume defining component;
b) adding an amount of electrolyte inside the pouch; and
c) sealing the pouch so that the pressure inside the sealed pouch is subatmospheric
   wherein the amount of electrolyte added is such that subsequent to the sealing a portion of the inner volume of the sealed pouch is substantially empty.

In some embodiments, a pouch cell comprises one empty-volume defining component. In some embodiments, a pouch cell comprises more than one empty-volume defining component, for example two, three, four or even more empty-volume defining component.

In some embodiments, an empty-volume defining component comprises a porous sheet. In some embodiments, the porous sheet is between about 50 micrometers and about 300 micrometers thick.

In some embodiments, the pouch cell is a lithium-ion chemistry pouch cell. That said, in some embodiments the pouch cell has a different chemistry.

Unless otherwise defined, all technical and scientific terms used herein have the same meaning as commonly understood by one of ordinary skill in the art to which the invention pertains. In case of conflict, the patent specification, including definitions, will control.

As used herein, the terms “comprising”, “including”, “having” and grammatical variants thereof are to be taken as specifying the stated features, integers, steps or components but do not preclude the addition of one or more additional features, integers, steps, components or groups thereof.

As used herein, the indefinite articles “a” and “an” mean “at least one” or “one or more” unless the context clearly dictates otherwise.

### BRIEF DESCRIPTION OF THE FIGURES

Some embodiments of the invention are herein described with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale. Specifically, the thicknesses of the layers are exaggerated relative to the length and width of the layers.

In the Figures:

FIGS. 1A, 1B, 1C and 1D (prior art) schematically depict prior art pouch cells;

FIG. 2 schematically depicts a pouch cell including an empty-volume defining component comprising two porous sheets sandwiching and thereby enveloping a flat laminated electrode assembly, in cross section;

FIGS. 3A and 3B schematically depict a pouch cell including an empty-volume defining component comprising a porous sheet wound about and thereby enveloping a spiral laminated electrode assembly;

FIG. 4 schematically depicts a pouch cell including an empty-volume defining component comprising a porous sheet located on one side of a flat electrode assembly;

FIG. 5 schematically depicts a pouch cell including an empty-volume defining component comprising a single folded porous sheet sandwiching and thereby enveloping a flat electrode assembly;

FIGS. 6A and 6B schematically depict a pouch cell including an empty-volume defining component comprising a spirally wound porous sheet located inside a core of a spiral laminated electrode assembly; and

FIGS. 7A and 7B schematically depict a pouch cell including a rigid solid porous empty-volume defining component located inside a core of a spiral laminated electrode assembly and a second empty-volume defining component that is substantially a pouch fashioned from a porous sheet containing and thereby enveloping the spiral laminated electrode assembly.

### DESCRIPTION OF SOME EMBODIMENTS OF THE INVENTION

The invention, in some embodiments thereof, relates to pouch cells and, more particularly, but not exclusively, to pouch cells that in some embodiments are adversely affected by formation of gas to a lesser extent than comparable pouch cells known in the art.

The principles, uses and implementations of the teachings of the invention may be better understood with reference to the accompanying description and figures. Upon perusal of the description and figures present herein, one skilled in the art is able to implement the teachings of the invention without undue effort or experimentation. In the figures, like reference numerals refer to like parts throughout. Before explaining at least one embodiment of the invention in detail, it is to be understood that the invention is not necessarily limited in its application to the details of construction and the arrangement of the components and/or methods set forth herein. The invention is capable of other embodiments or of being practiced or carried out in various ways. The phraseology and terminology employed herein are for descriptive purpose and should not be regarded as limiting.

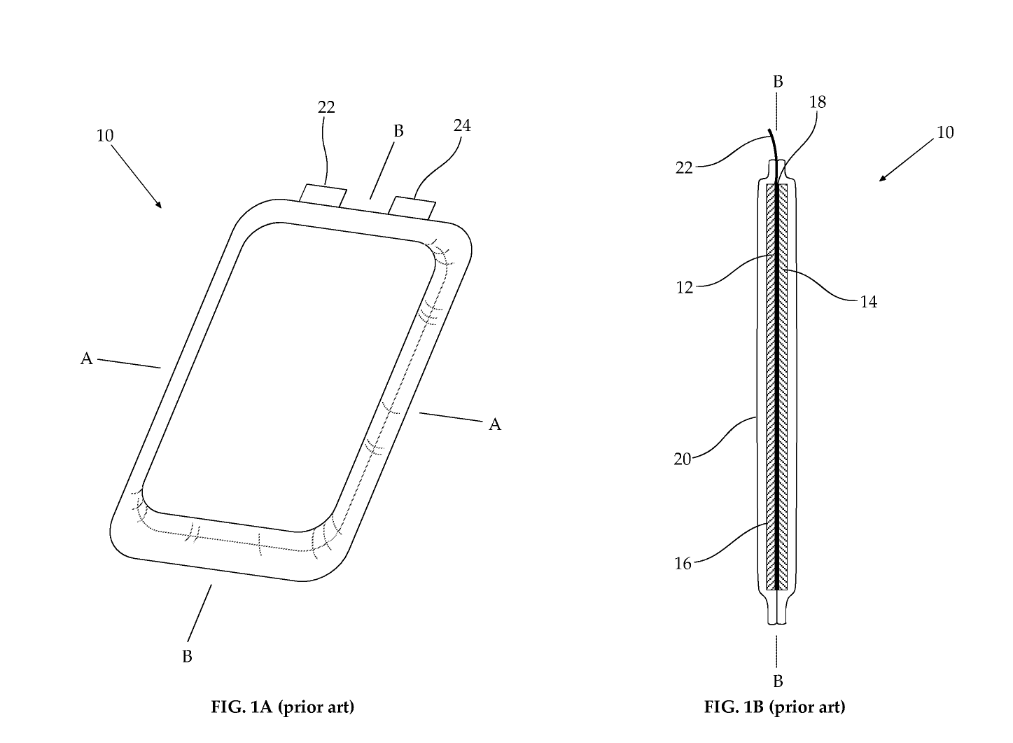

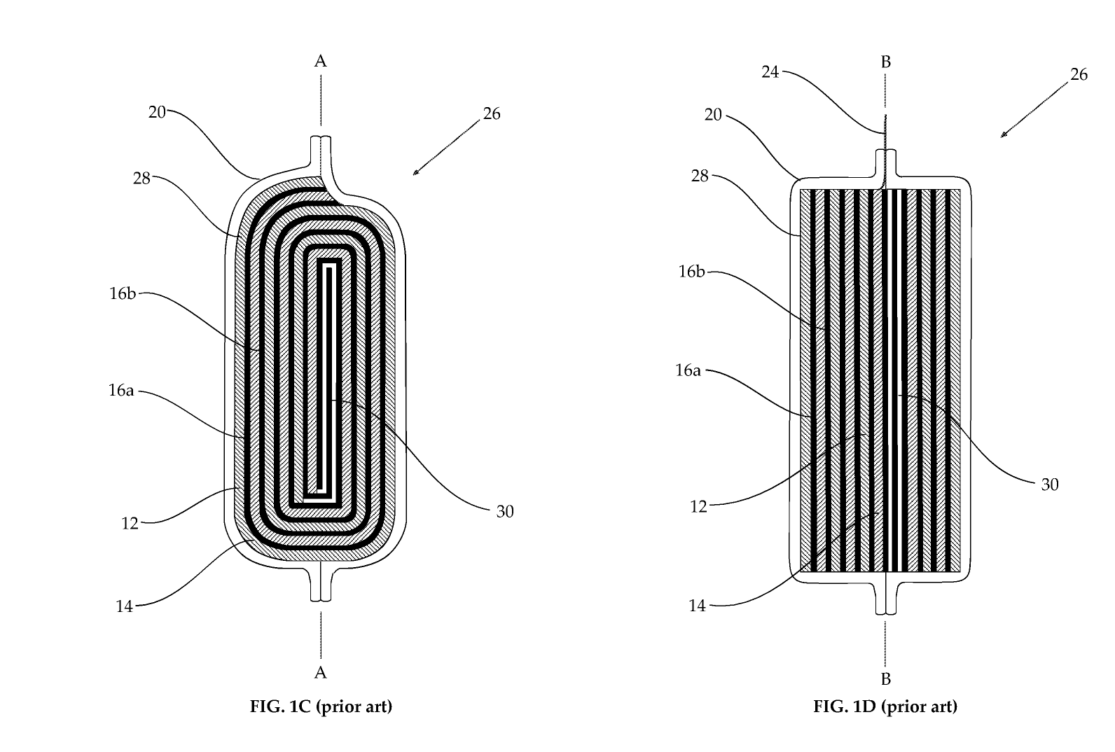

As discussed above, pouch cells, such as pouch cells 10 and 26 depicted in FIGS. 1A-1D include a flexible shell that constitutes a pouch 20 that contains other components of the pouch cell, including a laminated electrode assembly 18 or 28 and electrolyte. During the process of manufacturing the cell, prior to charging of the cell with electrolyte, a vacuum is produced inside the pouch. As a result, the pouch walls collapse inwardly so that the only empty volume inside the pouch is the volume defined by pores in the electrodes and separator. These pores are subsequently filled with electrolyte. As a result, the internal volume of such pouch cells is entirely filled by the components of electrode assembly 18 or 28, which pores and other empty volumes are completely filled with electrolyte, ensuring that the cell components are in mutual intimate contact and bathed in the electrolyte. If a gas is produced inside such a pouch cell, for example due to decomposition of electrolyte components, the walls of pouch 20 bulge outwards and some components are no longer in intimate contact, for example, the electrode layers of the electrode assembly move apart from the separator layers, reducing cell performance.

According to an aspect of some embodiments of the invention, a pouch cell is provided, where inside the pouch there is an amount of electrolyte such that a portion of the inner volume of the pouch is substantially empty and wherein the pressure inside the pouch is subatmospheric. As noted above, in some embodiments the substantially empty portion is configured to assist in reducing the extent of (or even preventing) bulging of the pouch caused by gas produced inside the pouch, by accommodating at least some of a gas produced inside the pouch, for example due to decomposition of components of the electrolyte. The substantially empty portion of the inner volume of the pouch is empty of solids and liquids, such as cell components. In some embodiments, the substantially empty portion of the inner volume contains an inert gas. In some embodiments and depending on the temperature, the substantially empty portion of the inner volume includes a vapor, for example of components of the electrolyte. Typically, the size of such a substantially empty portion is substantially temperature-independent in normal cell-operating conditions. In some embodiments, the substantially empty portion is maintained by the presence of an empty-volume defining component that prevents the walls of pouch 20 from completely inwardly collapsing due to the subatmospheric pressure inside pouch 20.

As known in the art and discussed in the introduction hereinabove, known pouch cells are made by placing an electrode assembly in a flexible pouch, evacuating gases from the pouch and adding a liquid or gel electrolyte. Presumably (though not certainly), in some instances the vapor pressure of at least one electrolyte component at operating temperatures of the cell is such that some insignificant amount of the electrolyte component is in the form of vapor that occupies a certain volume of the pouch cell. Herein, such a volume inside a pouch of a pouch cell that is substantially exclusively defined by the vapor pressure of an electrolyte component and consequently which size is entirely temperature dependent is considered to be an insubstantial substantially empty volume.

In contrast, some embodiments of the pouch cells described herein include a distinct empty-volume defining component that resists the collapse of the walls of pouch 20, such that a portion of the inner volume of the pouch is substantially empty despite the fact that the pressure inside the pouch is subatmospheric. Subsequent to manufacture, ambient pressure pressed the walls of a pouch of a pouch cell as described herein inwards. However, instead of compressing the empty volume until the pressure inside the pouch is equal to the ambient pressure, an empty-volume defining component resists the collapse to ensure that a portion of the inner volume of the pouch remains substantially empty and at subatmospheric pressure.

In some embodiments, if during operation of the pouch cell gas is formed inside the pouch, for example a gaseous product formed by decomposition of components of the electrolyte, the gas enters and is accommodated inside the substantially empty portion of the inner volume of the pouch. As long as the amount of gas formed is moderate so that the pressure inside the pouch is subatmospheric, the walls of the pouch do not bulge and cell performance is affected to a lesser degree than if there was no substantially empty portion of the inner volume of the pouch.

In some embodiments, the presence of an empty-volume defining component allows the pouch to be filled with a greater than usual amount of electrolyte. As a result, such a pouch cell includes excess electrolyte, so that decomposition of electrolyte does not lead to loss of cell performance due to electrolyte depletion.

According to an aspect of some embodiments of the invention there is provided a pouch cell, comprising: a) a flexible shell in the form of a pouch; b) inside the pouch, a laminated electrode assembly, comprising a positive electrode layer, a negative electrode layer and a separator layer disposed between the positive electrode layer and the negative electrode layer; and c) inside the pouch, an amount of electrolyte such that a portion of the inner volume of the pouch is substantially empty, wherein the pressure inside the pouch is subatmospheric.

According to an aspect of some embodiments of the invention there is also provided a pouch cell, comprising: a) a flexible shell comprising a pouch; b) inside said pouch, a laminated electrode assembly, comprising a positive electrode layer, a negative electrode layer and a separator layer disposed between said positive electrode layer and said negative electrode layer; c) inside said pouch, an amount of electrolyte such that a portion of the inner volume of said pouch is substantially empty; and d) inside said pouch, an empty-volume defining component wherein the pressure inside said pouch is subatmospheric.

Generally a pouch cell further comprises, as known in the art, a positive contact functionally associated with the positive electrode layer and apparent on the outside of the pouch, and a negative contact functionally associated with the negative electrode layer and apparent on the outside of the pouch.

In some embodiments, a pouch cell comprises one empty-volume defining component. In some embodiments, a pouch cell comprises more than one empty-volume defining component, for example two, three, four or even more empty-volume defining component.

Generally, the pressure inside the pouch is any suitable subatmospheric pressure, in some embodiments, less than about 1000 millibar at 298 K, not more than about 900 millibar at 298 K and even not more than about 800 millibar at 298 K. That said, the capacity of the substantially empty portion of the inner volume to accept gas produced inside the pouch increases with lower initial internal pressure. Thus, in some embodiments, the pressure inside the pouch is not more than about 500 millibar at 298 K, not more than about 100 millibar at 298 K, not more than about 10 millibar at 298 K and even not more than about 1 millibar at 298 K. In some embodiments, the pressure inside a pouch cell is determined by the vapor pressure of components of the electrolyte inside the pouch, that is to say is the vapor pressure of at least one component of the electrolyte.

In some embodiments, a pouch cell further comprises a resealable port (generally an integrally formed portion of the flexible shell) configured for evacuation of gas from inside the pouch. In some such embodiments, periodically or if needed, it is possible to evacuate gas from inside the pouch through the resealable port in order to reduce the pressure inside the pouch.

Generally, the substantially empty portion of the inner volume of the pouch is of any suitable size and is determined during implementation of a specific embodiment. That said, in some embodiments, the substantially empty portion constitutes at least about 1%, at least about 2%, at least about 5% and in some embodiments even at least about 10% of the inner volume of the pouch. The considerations as to a suitable size of the substantially empty portion of the inner volume of a specific embodiment of a pouch cell are known and may be implemented by a person having ordinary skill in the art upon perusal of the description herein. For example, the larger the substantially empty portion is, the greater the amount of gas that is potentially contained without substantially affecting performance of the pouch cell but leads to a reduction in the power density of the pouch cell.

### Flexible Shell Comprising a Pouch

Generally, any suitable flexible shell may be used in implementing the teachings herein. A flexible shell generally comprises a pouch as is known in the art. A pouch is of any suitable shape, for example, tubular, prismatic, square, rectangular, oval, circular, triangular and hexagonal.

A pouch is generally made of an impermeable (to water, oxygen, air and electrolyte solvent) flexible sheet material such as a (metalized) foil or a laminated structure including a (metalized) foil, see for example, EP 1422767; U.S. Pat. No. 6,042,966; US 2006/073277 and US 2009/0029245, which flexible sheets materials described therein are included by reference as if fully set forth herein.

In some embodiments, the walls of a pouch are between 10 and 200 micrometers thick.

A suitable sheet material suitable for implementing some embodiments of the teachings herein is described in US 2009/0029245 comprising a stainless steel foil of between 10 and 200 micrometer.

In some embodiments, a pouch is fashioned from a single sheet of material that is folded and contacting edges are sealingly secured together, for example by welding, as well-known in the art. In some embodiments, a pouch is fashioned from two or more sheets of material brought together, which edges are sealingly secured together, for example by welding.

In some embodiments, both a positive contact and the negative contact pass through a welded seam of the pouch.

### Positive Electrode Layer

Any suitable positive electrode layer including any suitable positive active material such as known in the art may be used for implementing the teachings herein, especially positive electrode layers suitable for use for lithium ion cells. Generally, a positive electrode layer is a sheet having a height, a width and a thickness, the electrode layer comprising a support substrate bearing a positive active material.

In some embodiments, a positive electrode layer is between 30 and 300 micrometer thick, typically between 100 and 200 micrometers thick.

A positive electrode layer is generally functionally associated with a positive contact, for example a wire or a strip of conductive material, integrally formed or attached, for example by welding, to the positive electrode layer, to transport electrons to and from the positive electrode layer.

Any suitable support substrate as known in the art may be used for implementing the teachings herein. Typically, a support substrate also acts as a collector to transport electrons between the positive contact of the cell and the positive electrode layer material. Suitable support substrates include foils and plates of materials such as aluminum, nickel, gold, stainless steel and combinations thereof.

Any suitable positive active material known in the art may be used for implementing the teachings herein, especially lithium intercalating positive active materials. Some embodiments include at least one positive electrode layer material selected from the group consisting of spinels, lithium metal oxides, lithium nickel oxides, lithium cobalt oxides, lithium manganese oxides, lithium iron oxides, LiCoO₂, LiNiO₂, LiCo₁₋ₓNiₓO₂ (0.01≧x≧1), mixtures of LiCoO₂ with LiMn₂O₄, mixtures of LiCoO₂ with LiNiO₂ and mixtures of LiMn₂O₄ with LiNiO₂, LiFePO4, LiFeSO₄, Li₂FePO₄F and LiMn₂O₄.

Any suitable method may be used for producing a positive electrode layer, for example as described in US patent publication 2008/0254367 or WO 2006/073277.

For example, positive active material is kneaded together with a conductive material such as acetylene black or carbon black, a binder such as poly(tetrafluoroethylene) (PTFE), poly(vinylidene fluoride) (PVDF), styrene-butadiene copolymer (SBR), acrylonitrile-butadiene copolymer (NBR), or carboxymethylcellulose (CMC) to give a positive electrode layer composition. The positive electrode layer composition is mixed with a solvent such as 1-methyl-2-pyrrolidone to form a slurry. A support substrate is coated with a layer of the positive electrode layer composition, and the coated support substrate heated at between about 50° C. and about 250° C. under vacuum for a sufficient time for drying, for example between 1 and 4 hours.

### Negative Electrode Layer

Any suitable negative electrode layer including any suitable negative active material such as known in the art may be used for implementing the teachings herein, especially negative electrode layers suitable for use for lithium ion cells. Generally, a negative electrode layer is a sheet having a height, a width and a thickness, the electrode layer comprising a support substrate bearing a negative active material.

In some embodiments, a negative electrode layer is between 30 and 300 micrometer thick, typically between 100 and 200 micrometers thick.

A negative electrode layer is generally functionally associated with a negative contact, for example a wire or a strip of conductive material, integrally formed or attached, for example by welding, to the negative electrode layer, to transport electrons to and from the negative electrode layer.

Any suitable support substrate as known in the art may be used for implementing the teachings herein. Typically, a support substrate also acts as a collector to transport electrons between the negative contact of the cell and the negative electrode layer material. Suitable support substrates include foils and plates of materials such as copper, gold, nickel, stainless steel and combinations thereof.

Any suitable negative active materials as known in the art may be used for implementing the teachings herein, including lithium ion intercalating negative active materials. Some embodiments include at least one negative electrode layer material selected from the group consisting of lithium metal, lithium alloys, metals (Sn, Si, Al, Pb), metal oxides (e.g., V₂O₅, V₆O₁₃, TiS₂, TiO₂, SnO₂, Li₄Ti₅O₁₂) and carbonaceous materials such as thermally decomposed carbons, cokes, graphites, fired organic polymers and carbonaceous fibers.

Any suitable method may be used for producing a negative electrode layer, for example as described in US patent publication 2008/0254367.

For example, powdered carbonaceous negative active material is mixed with a binder such as ethylene propylene diene terpolymer (EPDM), polytetrafluoroethylene (PTFE), poly(vinylidene fluoride) (PVDF), styrene-butadiene copolymer (SBR), acrylonitrile-butadiene copolymer (NBR) or carboxymethylcellulose (CMC) to give a negative electrode layer composition. The negative electrode layer composition is mixed with a solvent such as 1-methyl-2-pyrrolidone to form a slurry. A support substrate is coated with a layer of the slurry, and the coated support substrate heated at between about 50° C. and about 250° C. under vacuum for a sufficient time for drying, for example between 1 and 4 hours.

### Separator Layer

Any suitable separator layer, such as known in the art, may be used for implementing the teachings herein, especially separators suitable for use for lithium ion cells. Generally, a separator layer is a sheet having a height, a width, a thickness and is porous to the passage of lithium ions. Typical separator layers include sheets of microporous polyolefins (e.g., polyethylene or polypropylene film), other microporous films, woven fabrics and non-woven fabrics.

As is known in the art, it is preferred that a separator layer be as thin as possible in order to allow maximal power density of the cell, but must also by physically strong enough to increase cell reliability. In some embodiments, a separator layer is between 5 and 50 micrometers thick, typically between 20 and 35 micrometers thick. To ensure sufficient strength, the void volume (the percent of the separator that is void) of a separator layer is typically not more than 30%.

### Laminated Electrode Assembly

Any suitable laminated electrode assembly, such as known in the art, may be used in implementing the teachings herein, and generally includes one or more positive electrode layers, one or more negative electrode layers and one or more separator layers.

In some embodiments, for example in some embodiments where the laminated electrode assembly is flat (planar), an electrode assembly includes a single separator layer between positive electrode layer and negative electrode layer, similar to flat laminated electrode assembly 18 of pouch cell 10 depicted in FIG. 1B.

In some embodiments, for example in some embodiments having a spiral laminated electrode assembly, the electrode assembly includes two distinct separator layers between a positive electrode layer and a negative electrode layer, similar to spiral laminated electrode assembly 28 of pouch cell 26 depicted in FIG. 1C.

Generally, a positive electrode layer and a negative electrode layer are similar of size (height and width) and shape and are positioned parallel so that the respective edges coincide.

In some embodiments, the height and width of a separator layer or layers are not less than that of the positive electrode layer and the separator layer is positioned between the positive and negative electrode layer so that the separator layer effectively separates the two electrodes. In some embodiments, the height and/or the width of a separator layer are substantially greater than of the positive electrode layer.

### Electrolyte

Any suitable electrolyte may be used for implementing the teachings herein such as known in the art, for example a liquid or gel electrolyte solution including an electrolyte salt in a non-aqueous solvent. Typically, an electrolyte is made by mixing the components together.

Some embodiments include at least one electrolyte salt, e.g. a lithium salt, selected from the group consisting of LipF₆, LiBF₄, LiClO₄, LiN(SO₂CF₃)₂, LiN(SO₂C₂F₅)₂, LiC(SO₂CF₃)₃, LipF₄(CF₃)₂, LipF₃(C₂F₅)₃, LipF₃(CF₃)₃, LipF₃(iso-C₃F₇)₃, LipF₅(iso-C₃F₇) and Lithium bis(oxalato)borate (LiBOB). In some embodiments, two, three or more different electrolyte salts are used together in combination. In some embodiments, the concentration of the electrolyte salt in an electrolyte is between about 0.1 M and about 3 M, in some embodiments between about 0.5 M and about 1.5 M.

Some embodiments include at least one non-aqueous solvent selected from the group consisting of cyclic carbonates such as ethylene carbonate (EC), propylene carbonate (PC), butylene carbonate (BC), and vinylene carbonate (VC); linear carbonates such as dimethyl carbonate (DMC), ethyl methyl carbonate (EMC), diethyl carbonate (DEC), dipropyl carbonate (DPC); lactones such as gamma-butylolactone GBL; ethers such as tetrahydrofuran (THF), 2-methyl-tetrahydrofuran, 1,4-dioxane, 1,2-dimethoxyethane, 1,2-diethoxyethane, and 1,2-dibutoxyethane; nitriles such as acetonitrile; esters such as methyl propionate, methyl pivalate and octyl pivalate; and amides such as dimethylformamide (DMF); dimethyl sulfoxide (DMSO), N-methyl-2-pyrrolidone (NMP), and mixtures thereof.

In some embodiments, an electrolyte includes additives (see for example US patent publication 2008/0254367 and Abe K et al in J Power Sources 2008, 185, 449-455), the additives for adding desired properties such as increased safety or the formation of a solid-electrolyte interphase (SEI). Some embodiments include at least one additive such as listed in US patent publication 2008/0254367 and Abe K et al in J Power Sources 2008, 185, 449-455. Some embodiments include at least one additive selected from the group consisting of propargyl methyl carbonate (PMC), propargyl methyl sulfate (PMS), vinyl acetate (VA), allyl methanesulfonate (AMS) and vinylene carbonate (VC).

### Empty-Volume Defining Component

Any suitable empty-volume defining component may be used in implementing the teachings herein.

In general, an empty-volume defining component is as porous as possible, that is to say, the empty-volume defining component has a void volume (the percent of the separator that is void) that is as high as possible. In some embodiments, an empty-volume defining component has a void volume of not less than 50%. In some embodiments, an empty-volume defining component has a void volume of not less than 60%, not less than 70% not less than 80% and in some embodiments even a void volume of not less than 90%.

In some embodiments, an empty-volume defining component is substantially non-compressible, retaining substantially the same shape and dimensions whatever the pressure is applied through the pouch wall by the atmosphere.

In some embodiments, an empty-volume defining component is substantially rigid. In some such embodiments, the empty-volume defining component comprises a solid porous material. As discussed below, in some such embodiments, the empty-volume defining component is used as a mandrel for making a spiral laminated electrode assembly.

In some embodiments, an empty-volume defining component is flexible.

The empty-volume defining component may be fashioned of any suitable material or combination of materials. In some embodiments, an empty-volume defining component is fashioned from a material that is substantially inert to the electrolyte solution, for example, polyolefins and fluorinated polyolefins such as polyethylene, polypropylene or polytetrafluoroethylene.

An empty-volume defining component may be of any suitable size and shape. In some embodiments.

In some embodiments, an empty-volume defining component of a pouch cell comprises a porous sheet having a height, a width and a thickness. Typically, such a porous sheet is between about 50 micrometers and about 300 micrometers thick. In some embodiments, the height and width of such a porous sheet is not less than that of the positive electrode layer. In some embodiments, the height and/or the width of such a porous sheet is substantially greater than of the positive electrode layer.

In some embodiments, the porous sheet is substantially rigid. In some embodiments, the porous sheet is flexible. In some embodiments, the porous sheet is foldable.

Any suitable porous sheet may be used as an empty-volume defining component for implementing the teachings herein. For example, in some embodiments a porous sheet is of aggregated particles (e.g., sintered particles), fibers (e.g., a mesh, a net, a screen, a woven fabric, a non-woven fabric, a gauze) or a porous solid sheet (e.g., a sponge, expanded sheet, cut-out pores, for example a porous polyolefin film).

Suitable porous sheets include meshes known in the art of medicine, for example Optilene® Mesh or Premilene® polypropylene mesh (Aesculap AG, Tuttlingen, Germany); Mersilene polyester mesh, Prolene polypropylene mesh (Ethicon Inc. a Johnson and Johnson company, New Brunswick, N.J., USA); Bard Visilex® polypropylene mesh, Bard Dulex® expanded polytetrafluoroethylene mesh (Davol, Inc., Warwick, R.I., USA); Gore Infinit® PTFE mesh (W.L. Gore & Associates, Inc., Flagstaff, Ariz., USA); and Prolite™ polypropylene mesh and Prolite™ Ultra surgical polypropylene mesh (Atrium Medical Corporation, Hudson, N.H., USA).

In some embodiments, an empty-volume defining component is disposed outside the laminated electrode assembly. In some such embodiments, the laminated electrode assembly is a flat laminated electrode assembly or a spiral laminated electrode assembly including a core. In some such embodiments, the empty-volume defining component is located on one side of the laminated electrode assembly. In some such embodiments, the empty-volume defining component envelops the laminated electrode assembly, e.g. is wrapped around, folded around and/or is wound about the laminated electrode assembly. In some embodiments, the empty-volume defining component constitutes a pouch in which the laminated electrode assembly is contained.

In some embodiments, the laminated electrode assembly is a spiral laminated electrode assembly including a core and the empty-volume defining component is located inside the core. In some such embodiments, the empty-volume defining component comprises a spirally wound porous sheet. In some such embodiments, the empty-volume defining component comprises a porous solid core. In some such embodiments, the pouch cell further comprises a second empty-volume defining component disposed outside the laminated electrode assembly, as described above.

In some embodiments, an empty-volume defining component is fixed to at least part of a laminated electrode assembly. Any suitable method for fixing may be used, including the use of adhesive, threads, sutures, staples, rivets, pins and/or welding. In some embodiments, an empty-volume defining component is not fixed to a part of a laminated electrode assembly.

### Scavengers

It is known that some pouch cells, for example lithium ion chemistry pouch cells have reduced performance due to the presence of certain contaminants inside the pouch, for example in the electrolyte. In some embodiments, a pouch cell as taught herein includes at least one scavenger to reduce the negative effects of the contaminants.

One known contaminant is water. In some instances, over time and/or during cell-operation, water present inside the pouch reacts with electrolyte components yielding HF that adversely affects cell performance. In some embodiments, a pouch cell further comprises at least one water scavenger inside the pouch. Any suitable water scavenger or combination of water scavengers may be used, for example in some embodiments at least one water scavenger is lithium metal. In some embodiments, at least one water scavenger comprises particles. In some embodiments, at least one water scavenger is contained with the empty-volume defining component, e.g., comprises particles small enough to fit inside empty volumes defined by the empty-volume defining component.

Another known contaminant is HF. In some instances, over time and/or during cell-operation, HF is formed inside the pouch, adversely affects cell performance. In some embodiments, a pouch cell further comprises at least one HF scavenger inside the pouch. Any suitable HF scavenger or combination of HF scavengers may be used, for example in some embodiments at least one HF scavenger is ZnO, NaF or KF. In some embodiments, at least one HF scavenger comprises particles. In some embodiments, at least one HF scavenger is contained with the empty-volume defining component, e.g., comprises particles small enough to fit inside empty volumes defined by the empty-volume defining component.

Upon perusal of the description herein, a person having ordinary skill in the art is able to implement the teachings herein. A pouch cell in accordance with the teachings herein is made using any suitable method, especially methods analogous to methods of making known pouch cells, with the necessary modifications and changes. In some embodiments, a pouch cell is made according to the method disclosed herein.

According to an aspect of some embodiments of the invention, there is provided a method of making a pouch cell, comprising:

a) inside a flexible shell comprising a pouch placing:
a laminated electrode assembly, comprising a positive electrode layer, a negative electrode layer and a separator layer disposed between the positive electrode layer and the negative electrode layer; and
an empty-volume defining component;

b) adding an amount of electrolyte inside the pouch;

c) sealing the pouch so that the pressure inside the sealed pouch is subatmospheric wherein the amount of electrolyte added is such that subsequent to the sealing a portion of the inner volume of the sealed pouch is substantially empty.

In some embodiments, the method further comprises passing a positive contact functionally associated with the positive electrode layer through a seam in the pouch so that the positive contact is apparent on the outside of the sealed pouch and passing a negative contact functionally associated with the negative electrode layer through a seam in the pouch so that the negative contact is apparent on the outside of the sealed pouch.

In some embodiments, the method further comprises: metering the amount of electrolyte added. In such a way, a sufficient amount of electrolyte is added to saturate the separator and electrodes, yet ensuring that the substantially empty portion of the inner volume is of the desired size.

In some embodiments, the method further comprises: fixing the empty-volume defining component to at least a portion of the electrode assembly, by any suitable method. Depending on the embodiment, suitable methods include the use of adhesive, sewing with threads and sutures, using staples, rivets or pins and welding.

In some embodiments, the laminated electrode assembly is selected from the group consisting of a flat laminated electrode assembly and a spiral laminated electrode assembly.

In some embodiments, the placing of the electrode assembly and empty-volume defining component is such that the empty-volume defining component is disposed outside the laminated electrode assembly.

In some embodiments, the placing is such that the empty-volume defining component contacts a side of the laminated electrode assembly.

In some such embodiments, the empty-volume defining component comprises a porous sheet.

In some embodiments, the method further comprises: wrapping the porous sheet around the laminated electrode assembly so as to envelop the laminated electrode assembly.

In some embodiments, the porous sheet is foldable and the method further comprises: folding the porous sheet over the laminated electrode assembly so as to envelop the laminated electrode assembly.

In some embodiments, the porous sheet is flexible and the method further comprises: winding the porous sheet about the laminated electrode assembly so as to envelop the laminated electrode assembly.

In some embodiments, the laminated electrode assembly is a flat laminated electrode assembly, the empty-volume defining component comprises a porous sheet and the method further comprises: stacking sheets of material corresponding to sides of the shell, the electrode layers, the separator layer and the porous sheet in an appropriate order; and subsequently sealing a portion of a periphery of the sheets of material corresponding to the shell, thereby placing the laminated electrode assembly and the empty-volume defining component in the pouch.

In some embodiments, the laminated electrode assembly is a spiral laminated electrode assembly and the method further comprises: winding sheets constituting the positive electrode layer, the negative electrode layer and the separator layer around a mandrel functionally associated with a mandrel-rotating device thereby, thereby making the spiral laminated electrode assembly.

In some embodiments, the empty-volume defining component comprises a porous sheet and the method further comprises: prior to the winding of the sheets constituting the electrode layers and separator layer, winding the porous sheet around the mandrel, so that the empty-volume defining component is located in the core of the empty-volume defining component.

In some embodiments, the method further comprises: subsequent to the winding of the sheets constituting the electrode layers and separator layer, detaching the spiral laminated electrode assembly together with at least a portion of the mandrel from the mandrel-rotating device, the portion of the mandrel constituting at least a portion of the empty volume defining component. Generally, in such embodiments the portion of the mandrel is a porous material. In some embodiments, the portion of the mandrel is a solid porous material. In some embodiments, the portion of the mandrel is rigid.

In some embodiments, the method further comprises: subsequent to the winding of the sheets constituting the electrode layers and separator layer, detaching the spiral laminated electrode assembly from the mandrel-rotating device so as to leave a gap in a core of the spiral laminated electrode assembly; and placing the empty volume defining component in the gap.

In some embodiments, the method further comprises placing at least one water scavenger in the pouch. In some embodiments at least one water scavenger comprises lithium metal. In some embodiments, at least one water scavenger comprises particles. In some embodiments, at least one water scavenger is distributed over the empty-volume defining component so as to be contained within the empty-volume defining component. For example, in some embodiments the water scavenger is provided as particles smaller than the voids in the empty-volume defining component. When such embodiments are implemented, the water scavenger particles are contacted with the empty-volume defining component so that a substantial amount of the water scavenger particles enters the voids of the empty-volume defining component to be contained therein.

In some embodiments, the method further comprises placing at least one HF scavenger in the pouch. In some embodiments at least one HF scavenger comprises at least one of the group consisting of ZnO, NaF and KF. In some embodiments, at least one HF scavenger comprises particles. In some embodiments, at least one HF scavenger is distributed over the empty-volume defining component so as to be contained within the empty-volume defining component. For example, in some embodiments the HF scavenger is provided as particles smaller than the voids in the empty-volume defining component. When such embodiments are implemented, the HF scavenger particles are contacted with the empty-volume defining component so that a substantial amount of the HF scavenger particles enters the voids of the empty-volume defining component to be contained therein.

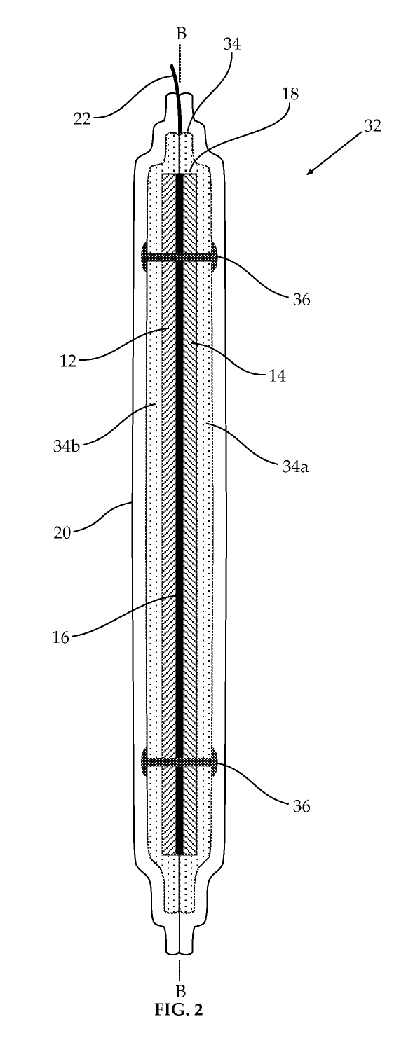

An embodiment 32 of a pouch cell in accordance with the teachings herein is schematically depicted in FIG. 2 in longitudinal (B-B) cross section.

Pouch cell 32 comprises a rectangular flexible shell in the form of a sealed pouch 20 (outer dimensions 30 cm by 20 cm) of heat-sealable laminated foil, inside which is contained a flat planar laminated electrode assembly 18 including a positive electrode layer 12, a negative electrode layer 14, a separator layer 16, an empty-volume defining component 34 and an amount of electrolyte such that a portion of the inner volume of pouch 20 is substantially empty. The pressure inside pouch 20 is subatmospheric, for example at a pressure determined by the vapor pressure of components of the electrolyte.

Positive contact 22 is functionally associated with positive electrode layer 12 and passes through a seam in pouch 20 so as to be apparent on the outside of pouch 20. A negative contact is functionally associated with negative electrode layer 14 and passes through a seam in pouch 20 so as to be apparent on the outside of pouch 20.

Positive electrode layer 12 and negative electrode layer 14 are of the same size (27 cm by 17 cm) and rectangular shape. Separator layer 16 is disposed between electrode layers 12 and 14. Separator layer 16 is of the same rectangular shape but wider and longer than electrode layers 12 and 14 (29 cm by 19 cm).

Empty-volume defining component 34 of pouch cell 32 comprises two individual porous sheets 34a and 34b of 200 micrometers thick mesh of woven polyethylene fibers having the same dimensions as separator layer 16 and having a porosity of 80%. The empty volume of the empty-volume defining component 34 is the empty volume between the warp and weft of the mesh. Empty-volume defining component 34 is substantially non-compressible, flexible and foldable.

Empty-volume defining component 34 of pouch cell 32 is disposed outside of flat laminated electrode assembly 18, where porous sheets 34a and 34b together envelop flat laminated electrode assembly 18.

Electrode layers 12 and 14 as well as separator layer 16 and porous sheets 34a and 34b are positioned centered with parallel edges so that the edges of electrode layers 12 and 14 coincide while the edges of separator layer 16 and empty-volume defining component 34 extend 1 cm in each direction from the edges of electrodes 12 and 14.

Passing through porous sheets 34a and 34b, electrode layers 12 and 14 and separator layer 16 are rivets 36 of polyethylene, thereby fixing empty-volume defining component 34 to electrode assembly 18.

In some embodiments, a pouch cell such as 32 is made by first stacking sheets corresponding to the components of an empty-volume defining component and a flat laminated electrode assembly in the appropriate order and orientation and then fixing together in a suitable fashion, for example with rivets (as in pouch cell 32), adhesive, threads, sutures, staples, pins, welding and the like. The flat assembly is then placed inside a flexible shell comprising a pouch in the usual way known in the art of pouch cells.

In some embodiments, a pouch cell similar to 32, but where the empty-volume defining component is not fixed to the electrode assembly, is made by stacking sheets of an empty-volume defining component, sheets constituting the components of the flat laminated electrode assembly and sheets constituting the pouch, and the pouch-cell formed and sealed in the usual way known in the art of pouch cells.

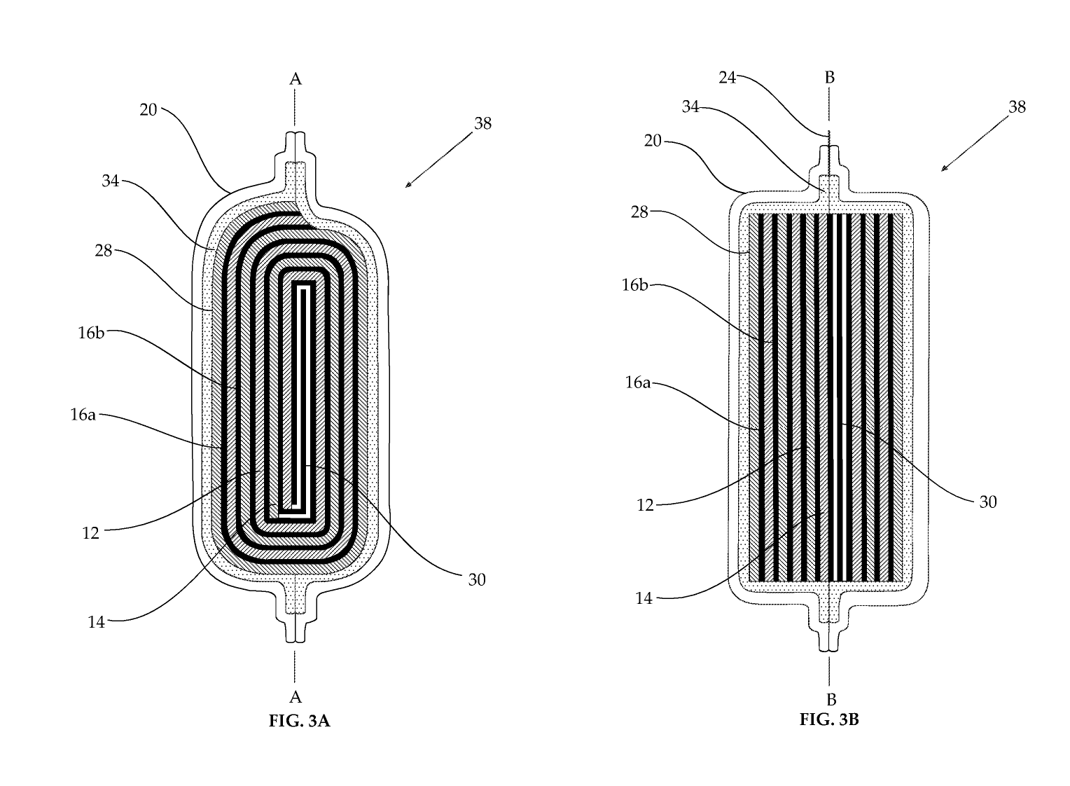

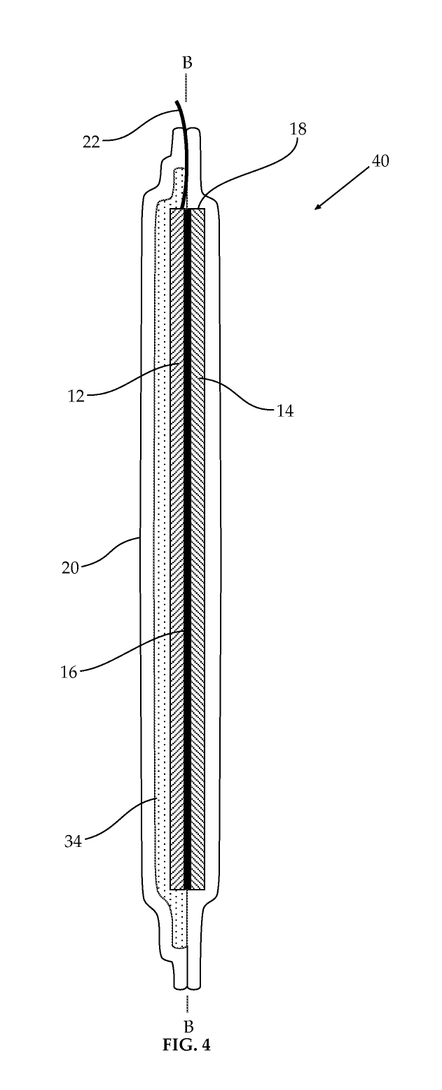

An additional embodiment 38 of a pouch cell in accordance with the teachings herein is schematically depicted in transverse cross section (A-A) in FIG. 3A and in longitudinal cross section (B-B) in FIG. 3B. Pouch cell 38 comprises a spiral laminated electrode assembly 28 and an empty-volume defining component 34 made of a single porous sheet of 300 micrometer mesh having a 70% porosity of woven polypropylene fibers. Empty-volume defining component 34 is longer than electrode assembly 28 and is wound about electrode assembly 28 so as to envelop electrode assembly 28.

In pouch cell 38, the ends of the porous sheet constituting empty-volume defining component 34 abut. In some similar embodiments, the ends of a porous sheet wound about an electrode assembly overlap to constitute an empty-volume defining component. In some similar embodiments, a porous sheet is wound so as to be spirally wound around an electrode assembly to constitute an empty-volume defining component.

In some embodiments, a spiral laminated electrode assembly such as 28 of pouch cell 38 is made in the usual way by winding on a mandrel. The spiral laminated electrode assembly is removed from the mandrel and then a porous sheet constituting the empty-volume defining component is wound around the electrode assembly so as to envelop the electrode assembly. The assembly is then placed inside a flexible shell comprising a pouch in the usual way known in the art of pouch cells

An additional embodiment 40 of a pouch cell in accordance with the teachings herein is schematically depicted in longitudinal cross section (B-B) in FIG. 4. Pouch cell 40 comprises an empty-volume defining component 34 comprising a single porous sheet located on one side of and that does not envelop flat electrode assembly 18.

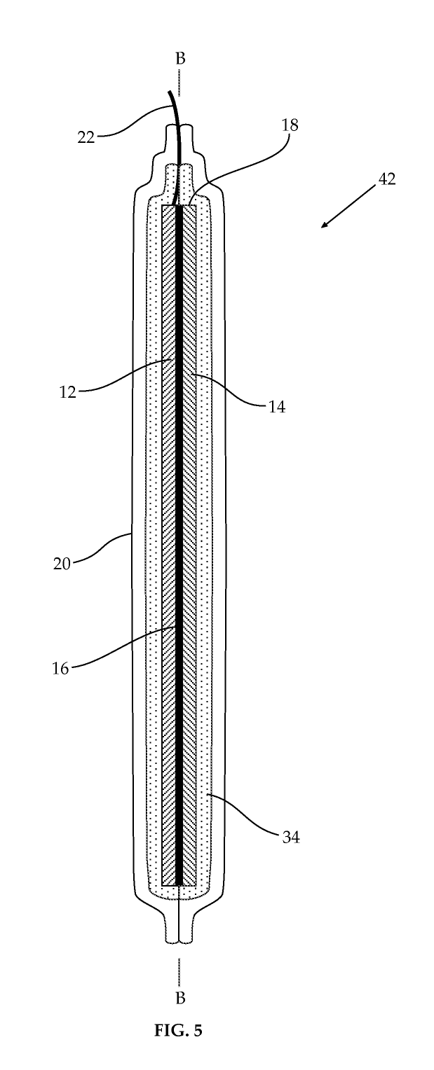

An additional embodiment 42 of a pouch cell in accordance with the teachings herein is schematically depicted in longitudinal cross section (B-B) in FIG. 5. Pouch cell 42 comprises an empty-volume defining component 34 comprising a single large folded porous sheet that envelops flat electrode assembly 18. In some related embodiments, an empty-volume defining component 34 is fashioned in the form of a pouch (made from one or more porous sheets) that envelops the electrode assembly.

In some embodiments, a pouch cell such as 42 is made by first stacking sheets corresponding to the components a flat laminated electrode assembly on a side of a porous sheet corresponding to an empty-volume defining component in the desired order, and then folding the porous sheet to envelop the components a flat laminated electrode assembly. The flat assembly is then placed inside a flexible shell comprising a pouch in the usual way known in the art of pouch cells

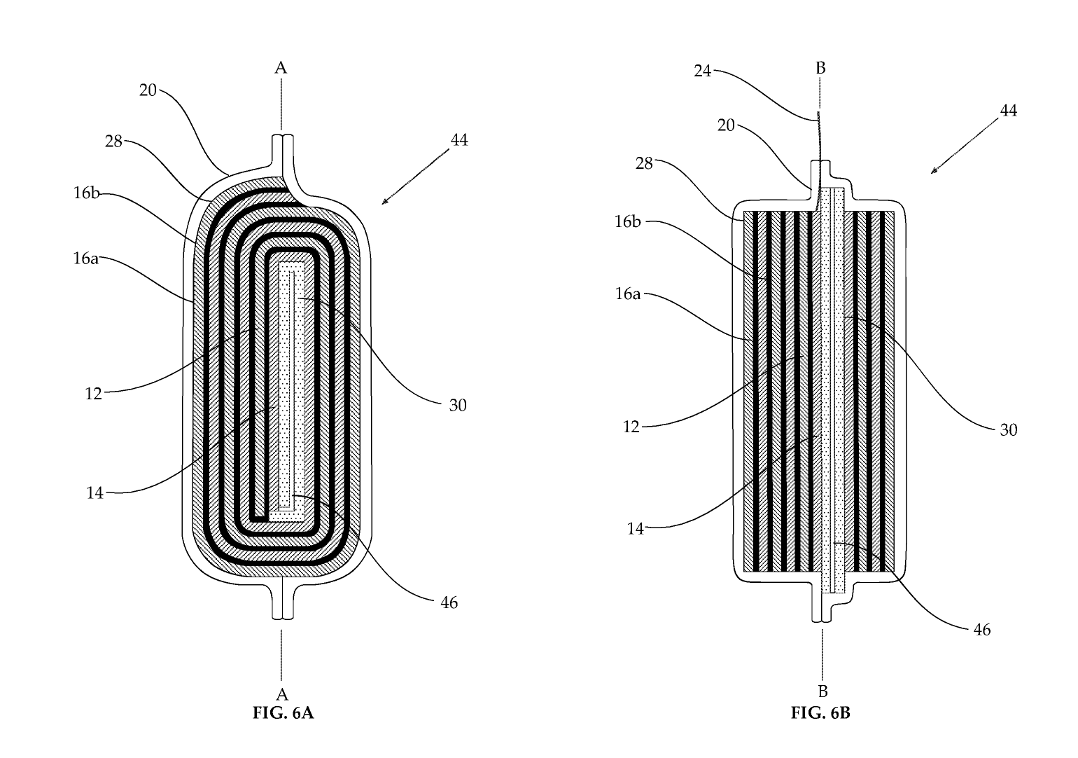

An additional embodiment 44 of a pouch cell in accordance with the teachings herein is schematically depicted in transverse cross section (A-A) in FIG. 6A and in longitudinal cross section (B-B) in FIG. 6B. Pouch cell 44 comprises a spiral laminated electrode assembly 28 and an empty-volume defining component 46 located inside core 30 of spiral laminated electrode assembly 28. Specifically, empty-volume defining component 46 is made of a single spirally wound porous sheet of 100 micrometer thick mesh having a 70% porosity of woven polyethylene fibers. Empty-volume defining component 46 is longer than electrode assembly 28.

In some embodiments, a spiral laminated electrode assembly such as 28 of pouch cell 44 is made in the usual way by winding on a mandrel. However, in some embodiments, prior to winding of the components of the electrode assembly, a porous sheet corresponding to the empty-volume defining component is wound around the mandrel so that the empty-volume defining component is located in a core of the empty-volume defining component.

Pouch cell 44 depicted in FIG. 6 comprises a single empty-volume defining component 46 located inside core 30 of spiral laminated electrode assembly 28. In some embodiments, a pouch cell comprises more than one empty-volume defining component. For example, in some embodiments a pouch cell such as pouch cell 44 includes an empty-volume defining component located inside a core of spiral laminated electrode assembly and a second empty-volume defining component disposed outside the laminated electrode assembly, for example analogously to the empty-volume defining component of pouch cells 32, 38, 40 and 42.

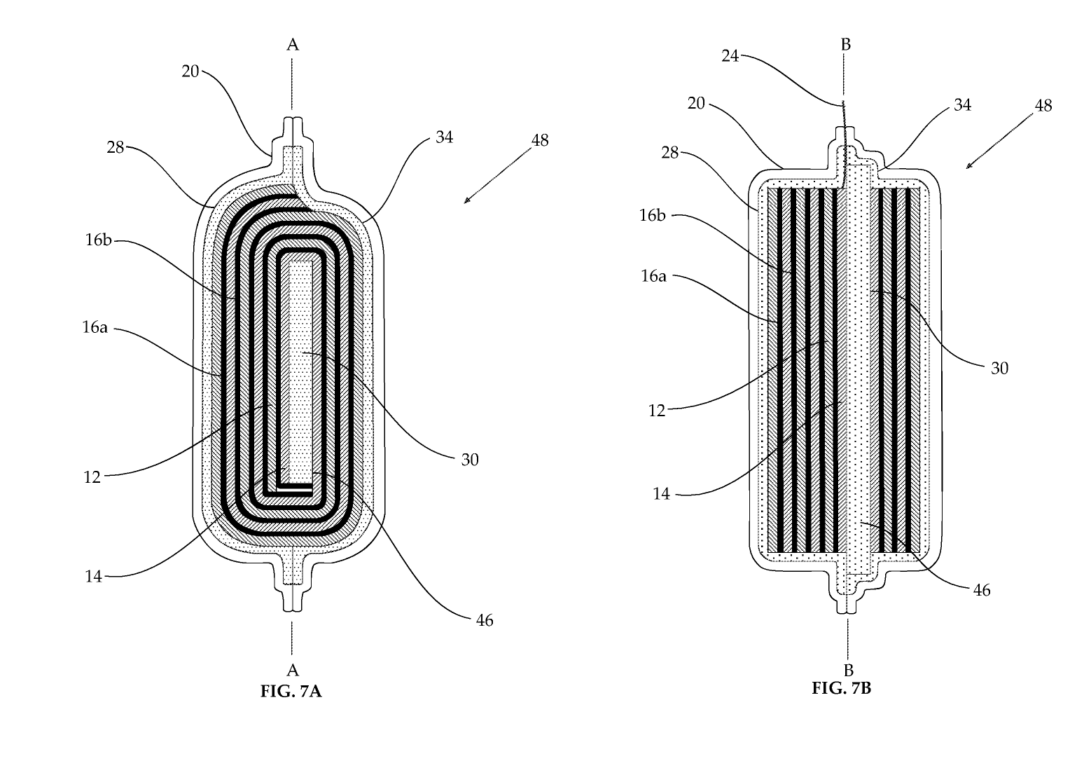

An additional embodiment 48 of a pouch cell in accordance with the teachings herein is schematically depicted in transverse cross section (A-A) in FIG. 7A and in longitudinal cross section (B-B) in FIG. 7B. Pouch cell 48 comprises a spiral laminated electrode assembly 28, an empty-volume defining component 46 located inside core 30 of spiral laminated electrode assembly 28 and a second empty-volume defining component 34 disposed outside of spiral laminated electrode assembly 28. Empty-volume defining component 46 is a solid and rigid rectangular porous block of sintered polyethylene having a pore size of 500 micrometers and a 70% void volume (commercially available, e.g., from MicroPore Plastics Inc., Tucker, Ga., USA). During the process of making spiral laminated electrode assembly 28, empty-volume defining component 46 is a portion of the mandrel around which the components of spiral laminated electrode assembly 28 are wound. Second empty-volume defining component 34 is substantially a pouch fashioned from a porous sheet of 200 micrometer thick mesh having a 70% void volume of woven polyethylene fibers. Both empty-volume defining component 46 and second empty-volume defining component 34 are longer than electrode assembly 28.

In some embodiments, a spiral laminated electrode assembly such as 28 of pouch cell 44 is made in the usual way by winding on a mandrel.

In some such embodiments, when winding is completed, the spiral laminated electrode assembly is detached and at least a portion of the mandrel is removed from the spiral laminated electrode assembly so as to leave a gap in the core of the spiral laminated electrode assembly, and subsequently, the empty-volume defining component is placed in the gap.

In some such embodiments, the empty-volume defining component is a part of the mandrel. In some such embodiments, when winding is complete, the spiral laminated electrode assembly is detached, together with at least a portion of the mandrel, from the mandrel-rotating device.

As noted above, some embodiments of pouch cells in accordance with the teachings herein, for example embodiments of any of pouch cells 32, 38, 40, 42, 44 and 48 include at least one water scavenger, such as particles of a water-scavenging material such as lithium metal inside a pouch 20. In some embodiments, the particles are contained within an empty-volume defining component, for example inside the voids of an empty-volume defining component or between layers of an empty-volume defining component (e.g., the layers of spirally-wound empty-volume defining component 46 of pouch cell 44).

As noted above, some embodiments of pouch cells in accordance with the teachings herein, for example embodiments of any of pouch cells 32, 38, 40, 42, 44 and 48 include at least one HF scavenger, such as particles of a HF-scavenging material such as ZnO, NaF and/or KF inside a pouch 20. In some embodiments, the particles are contained within an empty-volume defining component, for example inside the voids of an empty-volume defining component or between layers of an empty-volume defining component (e.g., the layers of spirally-wound empty-volume defining component 46 of pouch cell 44).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

1. A pouch cell, comprising:
a) a flexible shell in the form of a pouch;
b) inside said pouch, a laminated electrode assembly, comprising a positive electrode layer, a negative electrode layer and a separator layer disposed between said positive electrode layer and said negative electrode layer; and
c) inside said pouch, an amount of electrolyte such that a portion of the inner volume of said pouch is substantially empty
wherein the pressure inside said pouch is subatmospheric.

2. A pouch cell, comprising:
a) a flexible shell comprising a pouch;
b) inside said pouch, a laminated electrode assembly, comprising a positive electrode layer, a negative electrode layer and a separator layer disposed between said positive electrode layer and said negative electrode layer;
c) inside said pouch, an amount of electrolyte such that a portion of the inner volume of said pouch is substantially empty; and
d) inside said pouch, an empty-volume defining component
wherein the pressure inside said pouch is subatmospheric.

3. The pouch cell of claim 2, wherein said empty-volume defining component comprises a porous sheet.

4-5. (canceled)

6. The pouch cell of claim 2, wherein said empty-volume defining component is disposed outside said laminated electrode assembly.

7-9. (canceled)

10. The pouch cell of claim 2, wherein said laminated electrode assembly is a spiral laminated electrode assembly including a core and said empty-volume defining component is located inside said core.

11. The pouch cell of claim 10, wherein said empty-volume defining component comprises a spirally wound porous sheet.

12. The pouch cell of claim 10, wherein said empty-volume defining component comprises a porous solid core.

13. The pouch cell of claim 10, further comprising a second empty-volume defining component disposed outside said laminated electrode assembly.

14-16. (canceled)

17. The pouch cell of claim 2, further comprising at least one water scavenger inside said pouch.

18. The pouch cell of claim 17, wherein at least one said water scavenger comprises lithium metal.

19. The pouch cell of claim 17, wherein at least one said water scavenger comprises particles.

20. The pouch cell of claim 17, wherein at least one said water scavenger is contained within said empty-volume defining component.

21. The pouch cell of claim 2, further comprising at least one HF scavenger.

22. The pouch cell of claim 21, wherein at least one said HF scavenger comprises at least one of the group consisting of ZnO, NaF and KF.

23. The pouch cell of claim 21, wherein at least one said HF scavenger comprises particles.

24. The pouch cell of claim 21, wherein at least one said HF scavenger is contained within said empty-volume defining component.

25-30. (canceled)

31. The pouch cell of claim 2, wherein said empty-volume defining component is substantially non-compressible.

32. (canceled)

33. The pouch cell of claim 2, wherein said subatmospheric pressure is a vapor pressure of at least one component of said electrolyte.

34. A pouch cell, comprising:
a) a flexible shell in the form of a pouch;
b) inside said pouch, a laminated electrode assembly, comprising a positive electrode layer, a negative electrode layer and a separator layer disposed between said positive electrode layer and said negative electrode layer;
c) inside said pouch, an amount of electrolyte; and
d) inside said pouch, a water scavenger.

35. The pouch cell of claim 34, wherein at least one said water scavenger is lithium metal devoid of contact with said positive and negative electrode layers.
